(19) United States
(12) Patent Application Publication
(10) Pub. No.: US 2003/0226110 A1
(43) Pub. Date: Dec. 4, 2003

(54) Method for dynamically generating structured documents

(76) Inventor: Christian Scheering, Bielefeld (DE)

Correspondence Address: STAAS & HALSEY LLP, SUITE 700, 1201 NEW YORK AVENUE, N.W., WASHINGTON, DC, 20005, US

(21) Appl. No.: 10/444,087

(22) Filed: May 23, 2003

(30) Foreign Application Priority Data
May 29, 2002 (DE) 102 23 978.9
Jul. 18, 2002 (DE) 102 32 674.6

(51) Int. Cl. G06F 17/00

(52) U.S. Cl. 715/513

(57) ABSTRACT

Structured documents are dynamically generated on a host computer which communicates with a client and is preferably configured in an “embedded system” architecture. Requirement data from the client is received at the host computer and request parameters are extracted therefrom. The request parameters are mapped by a control module onto a command set of an architecture-specific interface module of the host computer. The structured document is then generated dynamically, using at least one template document which contains service takers. The service takers are executed in a runtime environment of the interface module, with reference to the mapped request parameters, and define contents or structure of the structured document after they have been executed. The dynamically generated structured document is then transferred to the client.

### CROSS REFERENCE TO RELATED APPLICATIONS

This application is based on and hereby claims priority to German Application No. 102 23 978.9 filed on 29 May 2002 and German Application No. 102 32 674.6 filed on 18 July 2002, the contents of which are hereby incorporated by reference.

### BACKGROUND OF THE INVENTION

The invention relates to a method for dynamically generating structured documents, which method can be implemented in host computers that are connected to packet-based networks.

Packet-based networks such as the World Wide Web (WWW), local area networks (LAN), etc., increasingly represent the main source of information exchange in many application areas for operators of computer systems.

Access to packet-based networks normally takes place using a workstation computer, which is connected via data lines to a host computer—also known as a “server” to the person skilled in the art—or to a cluster of host computers, and which runs a software program—also known as a “browser” to the person skilled in the art—for displaying the information which is available on the host computers or for navigating within the information.

A main component of such information is data which is present in text format, and which also contains graphics, cross-references to related information items—also known as a “links” to the person skilled in the art—and multimedia components such as video sequences, audio information, etc. This information is exchanged between a host computer, which can be selected by an address, and an associated communication endpoint—also known as a “client” to the person skilled in the art and taking the form of a browser for example—and is generally exchanged in the form of structured documents. By this is meant an arrangement of a delimitable quantity of data which, in addition to the actual information to be presented to the user, also contains computer-readable instructions about its structure or its presentation. The Hypertext Markup Language (HTML) format is predominantly used in the WWW today for exchanging structured documents.

It is known that a host computer or cluster of host computers for providing information over a packet-based network—also known as a “Web server” to the person skilled in the art—has generously dimensioned resources, i.e. processor power, working memory capacity, etc., which generally place virtually no limit on the execution of software products which support this provision of information.

However, with regard to a method according to the invention, the following description also considers host computers which have limited resources. Such a limitation on resources may be due to a restricted working memory capacity, for example, as in the case of host computers which are configured in an “embedded system” architecture, for example. This embedded system architecture is found in many so-called microcontroller-based host computers.

A host computer with restricted resources exists in the case of communication devices for switching communication terminals, for example, where the relevant communication devices are also equipped with functionality for exchanging information over a packet-based network. Such an exchange of information might be required for maintenance purposes, for example.

The Hypertext Transport Protocol (HTTP) is generally used for data transmission in packet-based networks such as the WWW, for example. HTTP is a general, status-free, object-oriented protocol. It describes a defined set of messages and replies, with which a client and a host computer communicate during an HTML session. A request from a browser to the host computer for a structured document represents an HTML session, for example. HTTP is also used for addressing objects by a so-called Uniform Resource Locator (URL), for example for addressing the host computer or files located via the host computer.

Provision of structured documents using an exclusive HTML format alone is sufficient for static information content, but is inadequate for advanced information transfer. It is often required to transfer structured documents to a client, where the contents—known as “content” to a person skilled in the art—or format or structure of the documents are dependent on specific conditions. Such a condition might be, for example, the language set by an operator and in which the information is to be presented on the client computer system. In the cases described, it is often technically more efficient to define the content or the structure of the structured document at runtime on the host computer and only after a corresponding call from the client has been received. In this way, the client sends requirement data to the host computer and receives a structured document which has been formatted in accordance with this requirement data. This process is therefore referred to as dynamic generation of structured documents, and the term dynamic HTML (DHTML) is often used in the case of dynamically generated HTML documents.

A frequently occurring instance of dynamically generated structured documents is a search request in databases. In this case, the search result is transferred to the client in a dynamically generated structured document.

For ease of readability, the term “HTML page” will be used henceforth to refer to structured documents. This term always refers to structured documents within the meaning of the general definition given at the beginning.

Various methods exist for dynamically generating or formatting HTML pages, and these are presented below.

Using so-called gateway interfaces such as Common Gateway Interface (CGI), Internet Server Application Programming Interface (ISAPI), etc., a browser can send an HTTP requirement for an executable application instead of a requirement for a static HTML page. The application selected by the client is executed on the host computer. The application can read the data associated with the requirement and determine what values were supplied with the requirement, e.g. values which an operator transferred by sending a completed HTML form. The application then analyzes the values in order to determine relevant information, and generates an HTML page which is sent to the client. A disadvantage of gateway programs is that they are difficult to create and change. Gateway programs are not integrated in HTML files. They require a completely different development process to that required for HTML files.

Executable runtime environments on the host computer represent another method for handling dynamic page contents or structures. In this case, techniques are used such as, for example, Active Server Pages (ASP), Java Server Pages (JSP), or “true” script languages such as Perl, PHP, Python, etc. As above, the scripts which are executed on the host computer allow dynamic HTML pages to be generated. When processing these scripts, a script interpreter or a “Java Virtual Machine” (JVM) in the case of Java component calls—also known as “JavaBeans”—is used for execution. These JavaBeans can themselves be incorporated in Java Server Pages or in pure so-called “servlets” which can be executed on the server side. In this way, a Java Server Page represents a mixture of static HTML expressions and dynamic object or JavaBean calls—also referred to subsequently as “service takers”. The Java Server Page is first converted into a servlet on the server side within the context of a so-called “servlet engine”. If the URL which corresponds to this Java Server Page is subsequently called by an external HTML browser client, the servlet engine for its part calls up the “precompiled” servlet, which then uses the integrated JavaBeans and dynamically generates the HTML content defined in the Java Server Page.

Instead of processing scripts on the host computer, the Java object-oriented programming language for dynamic HTML page generation can also be used to prompt interactive programs to run in a browser in the form of an “applet”. An applet is a program which is integrated within the HTML page. The actual program is precompiled on the host computer, and a reference to it is integrated in the HTML source code. When a call is made, the Java program is made executable and started by the JVM located on the destination computer of the client. The JVM can be installed on any operating system and processes the possibly precompiled program code of the host computer in a machine code which is executable on the destination computer.

While JavaBeans represent software components which are technically comparable with the “Component Object Model” (COM) of Microsoft Corp., applets are small applications which are executed by the JVM of a browser and provide an interface to the browser.

The use of “JavaScript” is a further way of dynamically generating HTML pages. Unlike the aforementioned script techniques, scripts written in the JavaScript format are not executed by the host computer which provides an HTML page, but by the browser on the destination computer. In this case, the JavaScript source code is integrated directly into the HTML page. JavaScript syntax is based on Java. Unlike Java, however, JavaScript is not precompiled.

In the following, the term “runtime environment” designates a software environment on the host computer for executing scripts, components—e.g. as per point 2 above—and/or precompiled scripts. The term “service takers”—known as “server components” to the person skilled in the art, for example as part of a “Java Server Page” (JSP)—refers to scripts or components within an HTML source code for an HTML document serving as a template, which scripts or components require a runtime environment for their execution by the host computer.

If a host computer or cluster of host computers with limited resources for providing service takers is used for HTML pages containing a dynamic formatting, the problem often occurs that “template documents”, as per the techniques described above for host computers with sufficient resources, cannot be transmitted directly to a host computer with limited resources or cannot be reused directly on the host computer by applying simple configuration measures. This is because template documents containing the aforementioned techniques generally require a combination of working memory capacity and processor speed for processing on the host computer, which capacity and speed cannot be provided by a host computer with limited resources.

There is a further problem in that, when template documents which have already been implemented for a host computer having sufficient resources are ported onto host computers having limited resources, the template documents have to be redeveloped-from the design phase, even though the functionality to be implemented is identical or at least almost identical on both host computer variants.

### SUMMARY OF THE INVENTION

An object of the invention is to specify a method which allows generation of structured documents having at least one of dynamic content and dynamic structure, wherein it is possible easily to port the template documents between host computers having limited resources and host computers having sufficient resources.

Requirement data is transferred from a client for a requirement relating to a structured document which is to be dynamically formatted, and is received at a host computer, where request parameters are extracted from the requirement data. These request parameters are mapped onto a command set of an architecture-specific interface module at the host computer. By mapping is meant that the requirement parameters are replaced by commands which can be understood by the interface module, or that requirement parameters are also ignored in the event that no associated command exists in the command set of the interface module. A structured document corresponding to the requirement data received at the outset is generated using at least one template document, which is stored on the host computer, for example, or on another computer system which is connected to the host computer via a packet-based network. The template document contains one or more service takers which are executed, with reference to the mapped request parameters, in a runtime environment which is provided by the interface module. As a result of this execution, contents—for example results of a search request in a database in a language which corresponds to the requirement data—or structure—for example a corresponding layout of the structured document—are provided for the document which is dynamically generated thus. This dynamically generated structured document is transferred to the client.

An essential advantage of a method according to the invention is that a template document, which exists in the form of a Java Server Page, for example, can be used both in a host computer with limited resources and in a host computer with sufficient resources for dynamically generating structured documents. The development cost for a template document of this type is therefore advantageously restricted to a single template document, which can be used on both of the aforementioned host computer environments after development.

So-called JavaBeans are advantageously used for defining the service takers of the template document. JavaBeans, used in conjunction with Java runtime environments, represent the most mature technology currently available for porting onto different host computer architectures.

It is particularly advantageous to use a method according to the invention for JavaBeans, since these provide a relatively simple call syntax. The use of JavaBeans also advantageously allows—using just one predefined JavaBean class—a simple generation of the structured document in a language which is preferred by the client side.

Language-dependent HTML contents advantageously exist in the form of language property data, which is accessed by service takers during dynamic page generation. The host computer can determine the preferred language, for example by querying a country setting which was set on the client system or a setting for the system language. Use of the same language property data and the same template document is therefore advantageously established both in a host computer having limited resources and in a host computer having sufficient resources.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a structural diagram for schematically representing the interaction of functional elements during dynamic generation of a structured document, and

FIG. 2 shows a schematic representation of structural elements of a template document.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

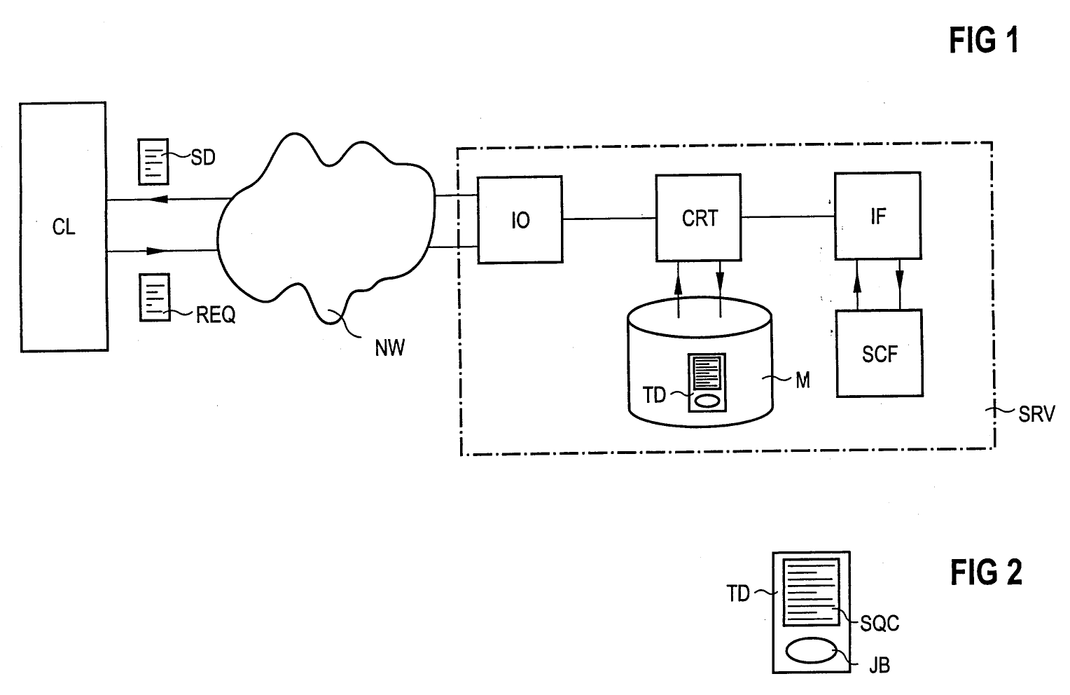

FIG. 1 illustrates a client CL connected to a host computer SRV via a packet-based network NW. The client—e.g. in the form of a workstation computer on which a browser is running—sends requirement data REQ to the host computer SRV via the packet-based network NW, and receives in return a structured document which has been dynamically formatted in accordance with the requirement data using a method which has yet to be represented. The host computer SRV has an “embedded system” architecture, i.e. it has limited resources in terms of working memory or processing power.

The direction arrows and associated lines which do not have reference characters are used in the drawing to illustrate more clearly the processes which occur, but must nonetheless be understood as pictorial since the processes which occur are packet-based and per se connectionless.

An input/output unit 10 assigned to the host computer SRV is used for a bidirectional exchange of data between the host computer SRV and the client CL via the packet-based network NW.

A control module CRT, which is connected to the input/output unit 10, accepts data which is received by the input/output unit 10 for further processing, or passes processed data to the input/output unit 10. The control module accesses a template document TD, which is stored in a memory unit M assigned to the host computer SRV. The document TD can alternatively be stored on any computer unit, including the computer unit of the client CL, in which case the control module accesses the document data via the packet-based network NW and via the input/output unit 10.

The control module is also connected to an interface module IF, which for its part communicates with host computer control functions SCF. By host computer control functions SCF is meant, for example, commands of the host computer SRV which are independent of the architecture, the relevant application program or the operating system. The interface module IF is therefore responsible—as explained below—in particular for the task of adapting to different host computer architectures.

The functional units of the host computer, in particular the control module CRT, the interface module IF, the input/output unit 10 and the host computer control functions SCF, can also be distributed among a plurality of computer systems in a known manner, for example in a client-server model, and exchange data via the packet-based network NW, for example.

With regard to limited resources on the host computer SRV, measures are required to use the template document TD, which was developed for a host computer having sufficient resources, for dynamically generating structured documents SD in the same way on the host computer SRV. Before describing these measures, the structure of the template document TD should first be examined more closely with further reference to the functional units in FIG. 1.

FIG. 2 shows a structural layout of the template document TD. The template document TD includes a source code part, the so-called “skeleton” SQC, for defining static content. This part is also called the “HTML skeleton” by the person skilled in the art, if the template document is defined by the Hypertext Markup Language (HTML) format. The skeleton SQC includes a source code and a text part, which contain static contents for defining the dynamically structured document SD which is to be generated. The skeleton SQC can also include separate language property data, embedded graphics, and other multimedia components, or references to these, though these are not shown here.

Dynamic sections of the structured document SD are defined using JavaBeans JB as a further component of the template document TD. By executing the JavaBeans of the template document TD, which is for example formatted as a “Java Server Page”, in a corresponding runtime environment, for example a so-called “parser”—explained below—or a Java Virtual Machine (JVM), dynamic contents of the structured document SD are generated with reference to the requirement data REQ.

The dynamic generation of the structured document SD in the host computer SRV is now explained with reference to FIG. 1. The requirement data SD which is sent to the host computer SRV in an HTTP request, for example, is received by the input/output unit 10 and forwarded to the control module CRT.

The control module CRT, the template document TD and the interface unit IF are arranged in functional terms according to a draft layout—also known as a “design pattern” by the person skilled in the art—which is designated “model/view/controller”.

The interface module IF (to be identified with the “model” in accordance with the aforementioned draft layout) includes application-specific, architecture-dependent software which, for example, permits database accesses or access to configuration parameters of the host computer by a defined command set. Therefore this access is generally to host computer control functions SCF.

The control module CRT (to be identified with the “controller” in accordance with the aforementioned draft layout) communicates the requirement data REQ supplied by the input/output unit 10 to the architecture-specific interface module IF. At the same time, request parameters (not shown) are extracted from the requirement data REQ which is passed to the interface module IF. Working together with the template document TD (to be identified with the “view” in accordance with the aforementioned draft layout), the structured document SD which is to be generated in accordance with the requirement data REQ is dynamically generated and passed to the input/output unit 10, from where the structured document SD is transferred to the client CT via the packet-based network.

In a system having limited resources, such as the present host computer SRV, the runtime environment for correctly transforming the JSP is not formed by a JVM combined with a servlet engine, the combination being extremely demanding in terms of processing and storage capacity. Instead, the runtime environment is realized in the control module CRT by “slimmer” software implementations which are also independent of the architecture of the host computer SRV, the software implementations being programmed in the language C++ for example. This runtime environment essentially includes a simplified parser and a so-called “scheduler”. Neither the parser nor the scheduler is illustrated in the drawing.

A parser is a program which replaces text parts of a document with commands or codes. The parser performs a semantic analysis of the text for this purpose. A scheduler performs sequence-control functions.

Within this runtime environment, the JavaBeans JB embedded in the skeleton SQC of the template document, or calls of these JavaBeans JB, are extracted by the parser and the scheduler and mapped onto a corresponding command set of the interface module IF. In this case, the mapping can be configured to be very simple, for example by restricting it to a very small subset of the JavaBean or JSP syntax. This allows a similarly simple “slim” configuration of the parser, without a JVM or a serviet engine, on an embedded system.

An example of such JavaBean calls relates to the representation in different languages of otherwise identically structured documents. In this case, the language-dependent generation of the structured document SD to be generated is implemented by a special JavaBean JB in the template document TD, which JavaBean accesses so-called “property files” via the interface document IF, in order to generate the target-language expression in the generated structured document SD.

The invention has been described in detail with particular reference to preferred embodiments thereof and examples, but it will be understood that variations and modifications can be effected within the spirit and scope of the invention.

What is claimed is:

1. A method for dynamically generating structured documents on at least one host computer which communicates with a client, comprising:
receiving requirement data from the client at the host computer,
extracting request parameters from the requirement data,
mapping the request parameters, by a control module, to a command set of a software-architecture-specific interface module of the host computer,
dynamically generating a structured document using at least one template document which contains calls of service takers executed in a runtime environment of the control module, with reference to the mapped request parameters, to define at least one of contents and structure of the structured document after completion of execution, and
transferring the structured document to the client.

2. The method as claimed in claim 1, wherein the template document includes an area for representing static parts and an area containing the service takers.

3. The method as claimed in claim 2, wherein the source code of the template document is formatted in accordance with HTML.

4. The method as claimed in claim 3, wherein the service takers of the template document exist as JavaBeans.

5. The method as claimed in claim 4, wherein the template document contains language property data.

6. The method as claimed in claim 5, further comprising emulating at least one of a Java runtime environment and a servlet engine in the interface module.

7. The method as claimed in claim 6, further comprising extracting and mapping the instructions of the service taker onto the architecture-specific runtime environment of the host computer by a parser and a scheduler in the interface module.

8. The method as claimed in claim 7, wherein the template document exists as a Java Server Page.

9. The method as claimed in claim 8, wherein said generating includes using a Java Virtual Machine to process the service takers of the template document.

10. A system for dynamically generating structured documents on at least one host computer which communicates with a client, comprising:
a storage unit to store a template document containing calls of service takers on the host computer;
a receiver module to receive requirement data from the client at the host computer;
a control module, coupled to said receiver module, to extract request parameters from the requirement data, to map the request parameters to a command set of said system and to dynamically generate a structured document using the template document by executing the service takers in a runtime environment of the control module, with reference to the mapped request parameters, to define dynamic contents of the structured document after execution is completed; and
an interface module to convert between an architecture-specific command set of the host computer and the command set of the system.
